(19) United States
(12) Patent Application Publication
(10) Pub. No.: US 2006/0092210 A1
(43) Pub. Date: May 4, 2006

(54) Color sensor counterfeit ink detection

(76) Inventors: Selvan Maniam, Pinang (MY); Joh Joh Ng, Perak (MY); Khee Boon Lim, Penang (MY); Chee Wai Chia, Penang (MY)

Correspondence Address: AVAGO TECHNOLOGIES, LTD., P.O. BOX 1920, DENVER, CO, 80201-1920, US

(21) Appl. No.: 10/977,574

(22) Filed: Oct. 29, 2004

(51) Int. Cl. B41J 29/393

(52) U.S. Cl. 347/19

(57) ABSTRACT

A counterfeit ink detector comprises a color printer calibrated by determining authentic ink color values for several authentic inks used by the color printer. A multi-color pattern is printed using multi-colored inks of a print cartridge. A light source outputs light to the color pattern and a color sensor detects light from the light source reflected from the color pattern. A processor processes the detected light to calculate pattern color values for color components of the color pattern, and compares the pattern color values to the authentic ink color values. A counterfeit ink signal is output by the processor if the difference between the pattern color values and the authentic ink color values is greater than a threshold value indicating counterfeit ink.

### FIELD OF THE INVENTION

The invention relates to the field of detecting counterfeit ink.

### BACKGROUND OF THE INVENTION

Color printers are becoming more popular and are taking over from black and white printers such as monochrome inkjet and dot matrix printers. Moreover, the color quality of the prints made by color printers has become photo-like due to the increase of the number of inks used from the conventional 3 different color inks to as many as 6 or even 8 different color inks.

The use of more inks has resulted in more expensive ink cartridges thereby providing motivation for counterfeited ink and/or ink cartridges for use in color printers. Counterfeiters refill authentic, but used, ink cartridges with counterfeit inks or else provide an entire counterfeit cartridge with counterfeit inks. Selling printer cartridges and ink is an important source of revenue for printer manufacturers. This counterfeiting has seriously hurt the revenues of printer manufacturers. Moreover, the widespread use of cheap clone ink cartridges and ink refill kits can make the quality of the printer seem poor and hurt the reputation of the printer manufacturer.

It would be desirable to give a printer the ability to detect when it is being used with counterfeit inks. Such an ability would allow printer manufacturers to stop the use of such counterfeit inks.

### SUMMARY OF THE INVENTION

The present invention provides a reliable counterfeit ink detector and counterfeit ink detection method.

A counterfeit ink detector comprises a color printer calibrated by determining authentic ink color values for several authentic inks used by the color printer. A multi-color print cartridge is inserted into the color printer. A multi-color pattern is printed using multi-colored inks of the print cartridge. A light source outputs light to the color pattern. A color sensor detects light from the light source reflected from the color pattern. A processor processes the detected light to calculate pattern color values for color components of the color pattern, and compares the pattern color values to the authentic ink color values. A counterfeit ink signal is output by the processor if the difference between the pattern color values and the authentic ink color values is greater than a threshold value to therefore indicate that the multi-colored inks of the print cartridge are counterfeit.

A method for detecting counterfeit ink used by the counterfeit ink detector comprises: calibrating the color printer by determining authentic ink color values for several authentic inks used by the color printer; inserting a multi-color print cartridge into the color printer; printing a multi-color pattern using multi-colored inks of the print cartridge; outputting light to the color pattern from a light source; detecting light from the light source reflected from the color pattern using a color sensor; processing the detected light to calculate pattern color values for color components of the color pattern; comparing the pattern color values to the authentic ink color values; and outputting a counterfeit ink signal if the difference between the pattern color values and the authentic ink color values is greater than a threshold value to therefore indicate that the multi-colored inks of the print cartridge are counterfeit.

### BRIEF DESCRIPTION OF THE DRAWINGS

FIG. 1 illustrates a configuration of the counterfeit ink detector of the present invention.

FIG. 2 is a black and white representation of a multi-color test pattern comprising multiple colored squares of different colors used by the invention of FIG. 1 to detect counterfeit ink.

FIG. 3 illustrates tabulated data of the differences of xyY values for red, green, blue, cyan, magenta, yellow and gray scale between Hewlett Packard® ink and Saint® ink.

FIG. 4 is a plot of the delta xyY values of FIG. 3 vs. the gradient of the colors.

FIG. 5 is a flowchart of the method for detecting counterfeit ink used by the counterfeit ink detection system of FIG. 1.

### DETAILED DESCRIPTION

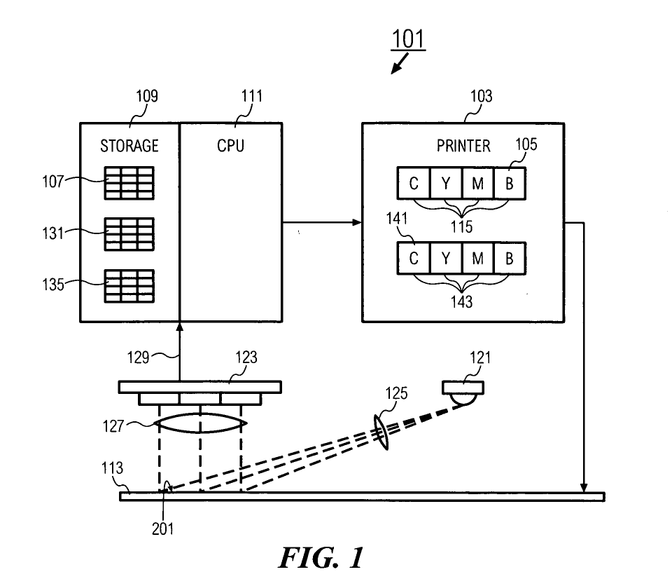

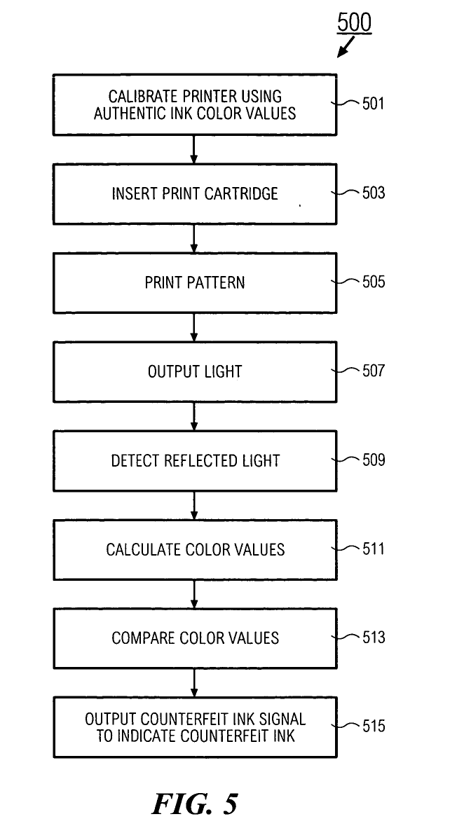

FIG. 1 illustrates a configuration of a counterfeit ink detection system 101 of the present invention. FIG. 5 is a flowchart of the method 500 for detecting counterfeit ink used by the counterfeit ink detection system 101.

At step 501 a printer 103 is calibrated. The printer can be a HP DESKJET 890c printer, for example. An authentic color ink cartridge 105 is inserted into the printer 103. The authentic color ink cartridge includes authentic cyan, yellow, magenta and black inks 115, for example. Here authentic can mean “authorized by the printer manufacturer” or at least can mean that it is not counterfeit.

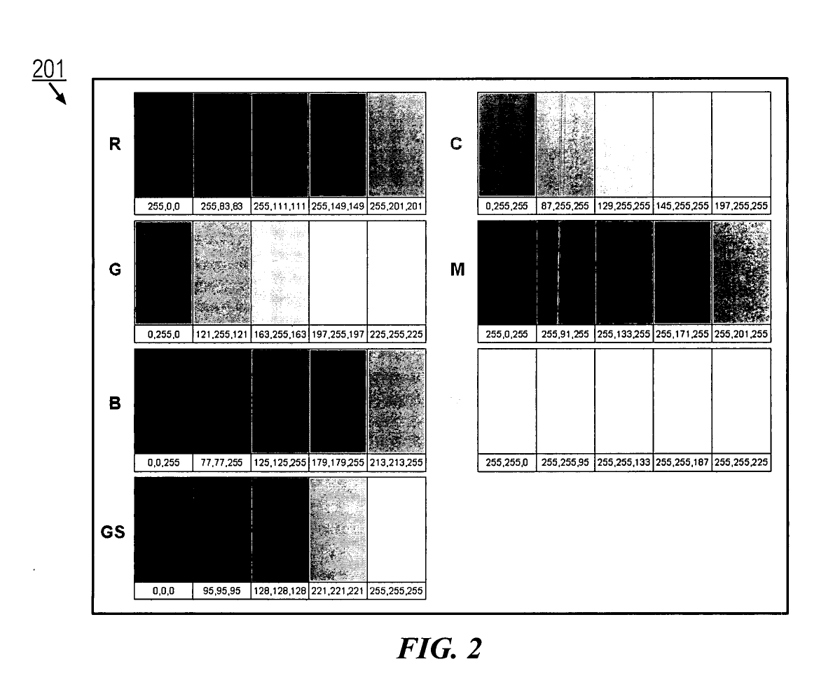

Multi-color test pattern data 107 is stored in a storage section 109. This data 107 is processed by a CPU 111 and used by the printer 103 to print out, using the authentic inks 115, a multi-color test pattern 201 (see FIG. 2) comprised of multiple colored squares of different colors onto a media 113. FIG. 2 is a black and white representation of the actual pattern 201. The actual pattern 201 includes both the primary colors and secondary colors. The printed primary colors allows the detection of differences in ink color, while the printed secondary colors allows the detection of differences in ink mixing properties. The pattern 201 includes multiple tones of red, blue, green, cyan, yellow and magenta. The media 113 can be paper, for example.

Next, light 125 is output to the color pattern 201 from a light source 121. The light source 121 is preferably a broad spectrum source since such a source can capture more information about the pattern 201. A white LED (light emitting diode) is one such broadband source, although other LED colors or types of light sources can be used. One such white light producing LED can be a blue LED with yellow phosphor. Another type of light source that can be used is an RGB LED where red, green and blue LEDs are combined to produce white light. The choice of light source can be made based on the types of inks used by the printer 103.

A color sensor 123 detects light diffusely reflected from the pattern 201. Preferably the color sensor 123 detects reflected light 127 reflected orthogonally from the pattern 201 and media 113. The color sensor 123 can be a photo diode or light-to-voltage converter, for example. Also, multiple color sensors can be used in the system. Using more color sensors offers more accurate color detection. The color sensors can use various types of filters coated onto photodiodes, various types of interference filters and can have various shapes.

The color sensor 123 outputs to the CPU 111 sensor color values 129. These sensor color values 129 are processed by the CPU 111 to calculate authentic ink color values 131 (x,y, Y coordinates for example) for color components of the color pattern 201 and the authentic ink color values 131 are stored in the storage section 109. Thus the counterfeit ink detection system 101 is calibrated by programming it with authentic ink color values 131.

Alternatively, the calibration step 501 for calibrating the printer 103 can be performed by programming previously determined authentic ink color values 131 into the counterfeit ink detection system 101. In this way, for given types of ink the same authentic ink color values 131 can be programmed into many different counterfeit ink detection systems 101 associated with many printers so that the full calibration procedure need not be performed for every separate printer.

The subsequent steps for detecting counterfeit ink can be performed using the same printer 103, storage device 109, CPU 111, light source 121, and color sensor 123. In another embodiment, the calibration step 501 is performed using a different printer 103, storage device 109, CPU 111, light source 121, and color sensor 123. For example, the authentic ink color values 131 used in the calibration step might be determined from a system at the manufacturer's location and then used to calibrate a counterfeit ink detection system 101 of a color printer sold to a home or business consumer. In either embodiment, the important thing is that the counterfeit ink detection system 101 is calibrated using the authentic ink color values 131.

Next, a step 503 is performed whereby a multi-color print cartridge 141 using cyan, yellow, magenta and black inks 143 is inserted into the color printer 103. The counterfeit ink detection system 101 is then used to determine whether the multi-color print cartridge 141 is an authentic color ink cartridge or a color ink cartridge using counterfeit ink. The multi-color print cartridge 141 can include all the different inks in a single housing or can comprise separate housings each containing an ink of a different color.

At step 505, just as in the calibration step, the multi-color test pattern data 107 stored in the storage section 109 is processed by a CPU 111 and used by the printer 103 to print out, using the inks 143, the multi-color test pattern 201 (see FIG. 2) comprising multiple colored squares of different colors onto the media 113 (preferably onto a sheet of media 113 different than the sheet of media 113 used in step 501. Again, FIG. 2 is a black and white representation of the actual pattern 201.

Rather than printing the multi-color test pattern data 107 at step 505, an actual color image to be printed can be used as a test image. Such an image can be sent to the printer from a personal computer which in turn might receive the image from a scanner, digital camera, storage device, or as a download from the Internet. By using an actual image to be printed rather than the pre-defined multi-color test pattern data 107, the user does not have to waste paper printing an image that will only be used for counterfeit ink detection. Rather, the image will be one that the user wanted to print out.

At step 507, just as in the calibration step, the light 125 is output to the color pattern 201 from the light source 121.

At step 509, just as in the calibration step, the color sensor 123 detects light diffusely reflected from the pattern 201. The color sensor 123 can be a red-blue-green color sensor and the multi-colored inks 143 can include the colors cyan, yellow and magenta as well as black, for example. In other embodiments the color sensor 123 can be a cyan, yellow, magenta (CYM) color sensor or can be a sensor using other colors.

At step 511, the color sensor 123 outputs to the CPU 111 sensor color values 129. These sensor color values 129 are processed by the CPU 111 to calculate pattern color values 135 for color components (x,y, Y coordinates for example) of the color pattern 201. The pattern color values 135 are stored in the storage device 109 along with the authentic ink color values 131.

At step 513 the pattern color values 135 are compared to the authentic ink color values 131 to determine if the color pattern 201 was printed using counterfeit ink.

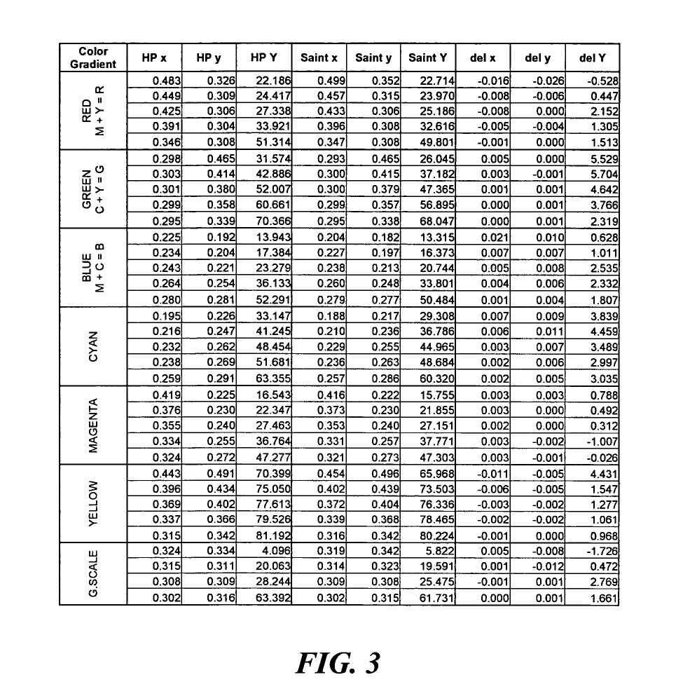

FIG. 3 illustrates tabulated data of the differences of xyY values for red, green, blue, cyan, magenta, yellow and gray scale between Hewlett Packard® ink and Saint® ink.

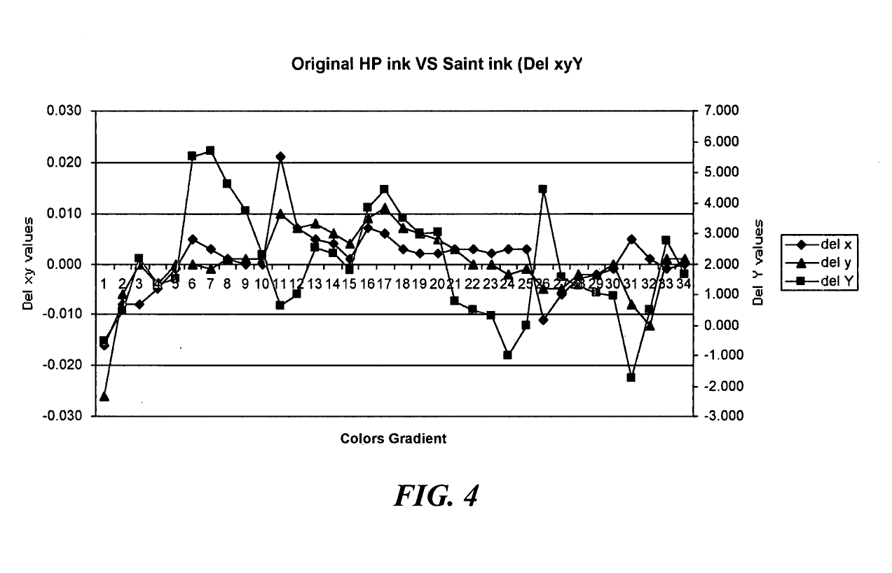

FIG. 4 is a plot of the delta xyY values of FIG. 3 vs. the gradient of the colors.

From FIGS. 3 and 4 it is apparent that the present invention distinguishes between different brands of ink.

At step 515 the counterfeit ink detection systems 101 outputs a counterfeit ink signal if the difference between the pattern color values and the authentic ink color values is greater than a threshold value to therefore indicate that the multi-colored inks 143 of the print cartridge 141 are counterfeit. The counterfeit ink output signal can be used to shut down the printer when the ink 143 is determined to be counterfeit ink. Alternatively or additionally, the counterfeit ink output signal can be used to send a message to the manufacturer of the printer 103 that counterfeit inks 143 are being used. The message can travel to the manufacturer at least in part over the Internet. The counterfeit ink output signal can also be used to provide a warning to a user of the printer 103 that the inks 143 are counterfeit.

The light source 121 and color sensor 123 used in both the calibration steps and can be embodied in a scanner, integral with the printer 103, or embodied in some other device.

In the above system and method, the processing and storage can be performed using a computer such as a personal computer. Alternatively, the processing and storage can be performed by an ASIC can have storage and processing capabilities. The ASIC can come as part of the counterfeit ink detection system 101 or can be a part of the printer 103.

In the foregoing specification, the invention has been described with reference to specific exemplary embodiments thereof. The specification and drawings are, accordingly, to be regarded in an illustrative sense rather than a restrictive sense.

1. A method for detecting counterfeit ink comprising:
calibrating the color printer by determining authentic ink color values for several authentic inks used by the color printer;
inserting a multi-color print cartridge into the color printer;
printing a multi-color pattern using multi-colored inks of the print cartridge;
outputting light to the color pattern from a light source;
detecting light from the light source reflected from the color pattern using a color sensor;
processing the detected light to calculate pattern color values for color components of the color pattern;
comparing the pattern color values to the authentic ink color values; and
outputting a counterfeit ink signal if the difference between the pattern color values and the authentic ink color values is greater than a threshold value to therefore indicate that the multi-colored inks of the print cartridge are counterfeit.

2. The method of claim 1, wherein the step of determining authentic ink color values for several authentic inks used by a color printer comprises:
printing a calibration color test pattern using an authentic print cartridge;
outputting light to the calibration color test pattern from a calibration light source;
detecting light from the calibration light source reflected from the color pattern using a calibration color sensor; and
processing the detected light to calculate the authentic ink color values.

3. The method of claim 1, wherein the step of calibrating the color printer by determining authentic ink color values for several authentic inks used by the color printer further comprises the step of programming the authentic ink color values into a storage device associated with the color printer.

4. The method of claim 1, further comprising the step of using the counterfeit ink output signal to shut down the printer.

5. The method of claim 1, further comprising the step of using the counterfeit ink output signal to send a message to a printer manufacturer, the message travelling at least in part over the Internet.

6. The method of claim 1, further comprising the step of using the counterfeit ink output signal to provide a warning to a user of the printer that the multi-colored inks are counterfeit.

7. The method of claim 1 wherein the light source is an LED.

8. The method of claim 1, wherein the step of printing a multi-color pattern comprises printing multiple colored squares of different colors.

9. The method of claim 1, wherein the step of printing a multi-color pattern comprises printing the multi-color pattern onto paper.

10. The method of claim 1, wherein the light source and color sensor are part of the printer.

11. The method of claim 1, wherein the light source and color sensor along with storage and a processor are part of a counterfeit ink detection module for connection to a printer.

12. The method of claim 1, wherein the color sensor is a Red-Blue-Green color sensor and the multi-colored inks include the colors Cyan, Yellow and Magenta.

13. The method of claim 1, wherein the multi-color print cartridge is in a single housing.

14. The method of claim 1, wherein the multi-color print cartridge is comprised of several separate housings each having a different color ink.

15. The method of claim 1, wherein the step of printing a multi-color pattern comprises printing a color image to be printed.

16. The method of claim 1, wherein the step of detecting light from the light source reflected from the color pattern using a color sensor comprises detecting light which is diffusely reflected perpendicularly from the color pattern.

17. A counterfeit ink detector comprising:
a color printer calibrated by determining authentic ink color values for several authentic inks used by the color printer;
a multi-color print cartridge inserted into the color printer;
a multi-color pattern printed using multi-colored inks of the print cartridge;
a light source outputting light to the color pattern;
a color sensor detecting light from the light source reflected from the color pattern;
a processor which processes the detected light to calculate pattern color values for color components of the color pattern, and compares the pattern color values to the authentic ink color values;
a counterfeit ink signal output by the processor if the difference between the pattern color values and the authentic ink color values is greater than a threshold value to therefore indicate that the multi-colored inks of the print cartridge are counterfeit.

18. The counterfeit ink detector of claim 17, wherein the color printer is calibrated by:
printing a calibration color test pattern using an authentic print cartridge;
outputting light to the calibration color test pattern from a calibration light source;
detecting light from the calibration light source reflected from the color pattern using a calibration color sensor; and
processing the detected light to calculate the authentic ink color values.

19. The counterfeit ink detector of claim 17, further comprising a storage device associated with the color printer programmed with the authentic ink color values

20. The counterfeit ink detector of claim 17, wherein the printer is shut down using the counterfeit ink output signal.

21. The counterfeit ink detector of claim 17, wherein the counterfeit ink output signal is used to send a message to a printer manufacturer, the message travelling at least in part over the Internet.

22. The counterfeit ink detector of claim 17, wherein the counterfeit ink output signal is used to provide a warning to a user of the printer that the multi-colored inks are counterfeit.

23. The counterfeit ink detector of claim 17 wherein the light source is an LED.

24. The counterfeit ink detector of claim 17, wherein the multi-color pattern comprises multiple colored squares of different colors.

25. The counterfeit ink detector of claim 17, further comprising paper upon which the multi-color pattern comprising the multi-color pattern is printed.

26. The counterfeit ink detector of claim 17, wherein the light source and color sensor are part of the printer.

27. The counterfeit ink detector of claim 17, wherein the light source and color sensor along with storage and a processor are part of a counterfeit ink detection module for connection to a printer.

28. The counterfeit ink detector of claim 17, wherein the color sensor is a Red-Blue-Green color sensor and the multi-colored inks include the colors Cyan, Yellow and Magenta.

29. The counterfeit ink detector of claim 17, wherein the multi-color print cartridge is in a single housing.

30. The counterfeit ink detector of claim 17, wherein the multi-color print cartridge is comprised of several separate housings each having a different color ink.

31. The counterfeit ink detector of claim 17, wherein the multi-color pattern comprises a color image to be printed.

32. The counterfeit ink detector of claim 17, wherein the light which is reflected from the color pattern and detected using the color sensor comprises light diffusely reflected perpendicularly from the color pattern.
